(19) United States
(12) Patent Application Publication
(10) Pub. No.: US 2023/0029358 A1
(43) Pub. Date: Jan. 26, 2023

(54) SYSTEM AND METHOD FOR MEASUREMENT OF PARTICIPANT COMMUNICATION WITHIN A TEAM ENVIRONMENT

(71) Applicant: Mark Thomas Tenenholtz, Morristown, NJ (US)

(72) Inventor: Mark Thomas Tenenholtz, Morristown, NJ (US)

(21) Appl. No.: 17/814,699

(22) Filed: Jul. 25, 2022

Related U.S. Application Data
(60) Provisional application No. 63/203,500, filed on Jul. 26, 2021.

(51) Int. Cl. G06Q 10/06; G06Q 10/10

(52) U.S. Cl. CPC G06Q 10/06398; G06Q 10/103

(57) ABSTRACT

A system for evaluating communication of a participant in a team setting including communication data of at least one participant, a computational infrastructure configured to receive the communication data and transpose the communication data into a machine-readable transcription, a communication representation platform configured to receive the machine-readable transcription wherein the communication representation platform selects at least one data set from the machine-readable transcription, applies a linear algebra technique to the at least one data set, and generates at least one score for the at least one data set, and a human-comprehensible output including at the least one score generated by the communication representation platform.

### CROSS-REFERENCE TO RELATED APPLICATION

This application claims the benefit of priority of U.S. provisional application No. 63/203,500, filed Jul. 26, 2021 the contents of which are herein incorporated by reference.

### BACKGROUND OF THE INVENTION

The present invention relates to team member participation and more particularly a system and method for measurement of participant communication within a team environment.

Neither humans nor software have been able to objectively judge how communication contributes to a team's ability to execute its mission. This means that it is very difficult to justify team coaching decisions in a data-driven manner, leading to inefficiency in the process. Most other products use indirect data collection methods such as questionnaires, and thus have a weaker relationship to participants' true communication traits. In addition, participants are measured only individually and not in group settings.

Further, the field of research that studies the calculation of quantitative metrics uses an entirely different class of machine learning models to numericize the textual data. Those models rely on corpora specific to the topic that end-users are discussing, whereas no current product uses a more modern approach trained on a significantly larger and more varied corpus.

There currently exists no other product that empirically evaluates team-based communication. Some products use questionnaires to evaluate post-communication emotional data, but no other product uses recording data from the communication itself. While individualized personality assessments are common, human behavior within a team is unique to the team, and no available product can meaningfully analyze it. By not measuring participants in the act of communicating, other systems are subject to greater noise in their measurements from sources such as the participant's confirmation bias.

As can be seen, there is a need for improved systems and methods for providing a direct measurement of how the participant communicates, providing the most representative and fair measurement.

### SUMMARY OF THE INVENTION

In one aspect of the present invention, a system for evaluating communication of a participant in a team setting comprising communication data of at least one participant, a computational infrastructure configured to receive the communication data and transpose the communication data into a machine-readable transcription, a communication representation platform configured to receive the machine-readable transcription wherein the communication representation platform includes a machine-readable program code for causing, when executed, the communication representation platform to perform a system method comprising the following process steps, selecting at least one data set from the machine-readable transcription, applying a linear algebra technique to the at least one data set, and generating at least one score for the at least one data set, and a human-comprehensible output wherein the human-comprehensible output comprises at the least one score generated by the communication representation platform.

The invention may provide a representative and fair measurement of the participant's communications and how participants communicate by providing quantified feedback and facilitating data-driven coaching methods that lead to better communication and execution outcomes by classifying team communication into critical factors for analysis with a machine learning process.

These and other features, aspects and advantages of the present invention will become better understood with reference to the following drawings, description, and claims.

### BRIEF DESCRIPTION OF THE DRAWINGS

FIG. 1 is a schematic flow chart of method steps for measuring and evaluating participant communication according to an embodiment of the present invention;

FIG. 2 is a schematic flow chart of audio data collection thereof;

FIG. 3 is a schematic flowchart of method steps performed by a computational infrastructure according to an embodiment of the present invention;

FIG. 4 is a schematic flowchart of method steps performed by a communication representation platform according to an embodiment of the present invention; and

FIG. 5 is a schematic flowchart of additional method steps performed by a communication representation platform according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, embodiments of the present invention provide a system and method for providing a measurement of participant communication in a team environment. The system and method may include a computer program product or a program code.

Aspects of the present invention may include communication data, a computational infrastructure, and a communication representation platform. In some embodiments of the present invention, the communication data may be collected or gathered by an audio recording device, an audio input device and/or voice recording software, hereinafter collectively referred to as an audio recording device. The communication data may be in an audio format or a text format. Alternatively, the communication data may be provided by a third party.

In some embodiments of the present invention, a user being evaluated may be recorded with the audio recording device. The user may equip the audio recording device before embarking on a task pertinent to a team goal (i.e., a user's primary job function). The recordings may be transmitted or provided to a computational infrastructure and analyzed by a communication representation platform.

The computational infrastructure performs any preprocessing on the data, including metadata collection. Preprocessing may include selecting or extracting relevant data, for example, unzipping files into a cloud environment. selecting or may further include selecting and/or transferring relevant files data sets, or series of data. Information in the metadata may include information on the participants, time of events, timestamps for audio or script segments, participant data for audio or script segments, location, etc. The metadata may be utilized to connect an individual participant's input data to that individual's ultimate results. The computational infrastructure may also collate and transpose input text into a useful format for the communication representation platform, such as a transcript (a transcription) or a plurality of transcripts.

Each participants' speech may be aligned or joined into a single script. The alignment may take place by first splitting and/or dividing individual participant's audio channels and recordings into discrete dialogue elements or portions of the dialogue. The portions may be merged into a unified script. Each participant's speech may be aligned by the metadata, for example, chronologically. In some embodiments, the alignment is performed by the voice recording software.

The audio input device and computational infrastructure may work together to translate the collected data into a numerical or machine-readable format. The format may be consumable, readable, or digestible by the communication representation platform. The communication representation platform then performs computations on the input data to provide an output, such as a numerical output, representative of the input data. The output may be a series of human-readable, critical factors.

The communication representation platform may rely on a model or models. The models may be machine learning models and may be trained on a task that is related to the goal of analyzing group communication to enable the communication representation platform to consume preprocessed data and output useful results. The task may train the model to understand similarities and differences between linked contributions, for example, contrastive pair tasks, entailment tasks, or paraphrasing tasks.

The corpus used to train the model may have enough variety to generalize to any reasonable subject matter that could apply to the tasks performed by the end-users. Model performance may be improved by training the model on more data, with the most benefit coming from a data/task pair that most closely represents analyzing group communication. Advantageously, in some embodiments of the present invention, the model need not be dependent on a specific subject, such as the subject matter being discussed by the end-user.

A model or models used in the communication representation platform may utilize voice audio data or text data or data sets or a series of data from the audio data or text data. The data may be utilized interchangeably by conversion for an appropriate model or models. For example, if the data collected is text data and the model may operate on numericized text data (i.e., a natural language processing model), then the computational infrastructure may perform necessary steps to clean the input text. If speech data is collected and the model is a text model, the computational infrastructure may include a speech-to-text translation or conversion. The necessary numericizing of the data, i.e., tokenizing in the case of textual data, can be performed within the communication representation platform to ultimately produce the same results.

A human-comprehensible output from communication representation platform may be provided in a variety of ways using numerous combinations of linear algebra techniques applied to data input into the communication representation machine, including using different techniques for different types of activities. Linear algebra techniques may include but are not limited to convolutions, dot products, and/or vector norms. Linear algebra techniques may be used at various stages within the communication representation platform. The linear algebra technique applied may generate or produce applicable factors or score categories. For example, convolutions may enable generation of gravitas, attentiveness, and logical flexibility scores within windows, and dot products and vector norms operate within those windows. In addition, predetermined data sets or series of data, such as audio or text data categorized by a metadata, may generate applicable factors or score categories.

In some embodiments, linear algebra techniques may be applied within the communication representation platform to an output of the models and/or to data provided to the communication representation platform. Linear algebra techniques may translate raw data or a raw output into human-comprehensible critical factors. These factors may make use of the qualitative interpretation of these linear algebra techniques, i.e., framing communication density as a semantic value as defined by the model outputs divided by the duration of the input. In some embodiments of the present invention, vectors or a set of vectors are generated by the model and compared. The comparison may be performed by the model. A variety or plurality of metrics may be utilized for comparison. For example, a cosine similarity, a dot product, and/or a Euclidean distance may be utilized to generate serviceable metrics for a comparison of model output. Predetermined data sets or series of data may be input into the model or models.

The linear algebra techniques may be applied by the communication representation platform to produce the human-comprehensible critical factors. These techniques may be applied to output of the model, raw data provided by the computational infrastructure, or output of other linear algebra techniques. Relevant or predetermined data from audio data or text data may be selected or extracted to form data sets or a series of data for application of linear algebra techniques. Selecting may include extracting a data set or series of data and inputting the dataset or series of data into a model to produce a separate data set or series of data for linear algebra application.

The human-comprehensible output may be provided and scored on factors, scores, or score categories including but not limited to participation, clarity, gravitas, attentiveness, and logical flexibility. Participation may measure how often a participant speaks relative to other members of the team. Participants who speak more may have a higher participation score. Clarity may measure how concisely a participant gets information across. The use of “filler” words may decrease a clarity score, and a high amount of information per word spoken may increase a clarity score. Gravitas may measure how often a participant's comments draw the attention of their teammates. A participant's gravitas may increase when their words are repeated by their teammates. Easy to understand or “sticky” ideas, as well as memes, may generate high gravitas. Attentiveness may measure how responsive a participant is to their teammates. When a participant echoes what a teammate says, the teammate's gravitas may increase, and the participant's attentiveness may simultaneously increase. Logical Flexibility may measure a tendency of a participant to follow a group's thought process. Participants who act independently rather than quickly responding to the immediate needs of the group may have a high logical flexibility.

The human-comprehensible critical factors, generated by the communication representation platform, may be analyzed for performance indicators. Indicators may include but are not limited to traits of each participant over repeated/recurring sessions and analysis of the traits of the group's communication. The analysis of these outputs may be performed over multiple sessions to gauge both the variability of each critical factor for the player/team and how it changes over time.

A method according to aspects of the present invention in measurement and assessment of a participant in a team environment may include the following. An activity to perform and a group to analyze may be identified and selected. An audio input device and voice recording software (or text recording software) may collect communication data of individual participants of the group or of the group as a whole while the group is performing the activity. Communication data of at least one participant may be collected. This data may be transmitted to or passed to the computational infrastructure configured to receive such for processing and transposition into a machine-readable transcription. The machine-readable transcription may be sent to a communication representation platform configured to receive such for generation of participant data in a human-comprehendible format. Generation of the human-comprehendible format may be provided by execution of a program code and at least one data set derived from the machine-readable transcription and application of a linear algebra technique to the at least one data set. Separate linear algebra techniques may be applied to the at least one data set or separate data sets, each forming a portion of the human-comprehendible format. The human-comprehendible format may include at least one score generated from the machine-readable transcription, i.e., application of a linear algebra technique, or at least one linear algebra technique, to the at least one dataset. The scores may include scoring on participation, clarity, logical flexibility, gravitas, and/or attentiveness.

The system of the present invention may include at least one computer with a user interface. The computer may include any computer including, but not limited to, a desktop, laptop, and smart device, such as, a tablet and smart phone. The computer includes a program product, or program code, including a machine-readable program code for causing, when executed, the computer or a portion of the present invention to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system including the audio recording device, computational infrastructure, communication representation platform, and method described above is for purposes of example only and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

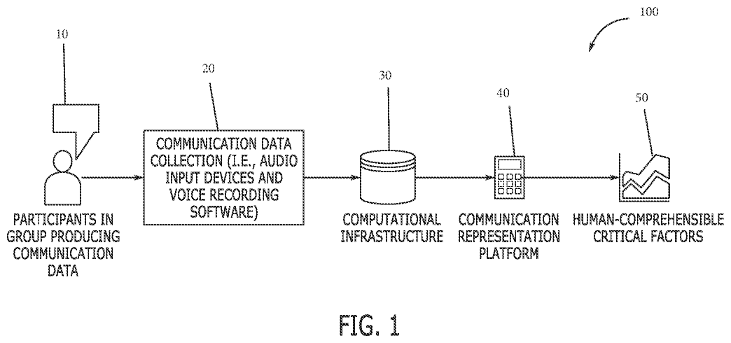

Referring now to FIGS. 1-5, FIG. 1 is a diagram of a method steps and infrastructure 100 according to an embodiment of the present invention. Participants in a group produce communication data 10. That communication data is collected 20 and sent to a computational infrastructure 30. The data is then sent to a first embodiment of a communication representation platform 40 and output in human-comprehensible critical factors 50.

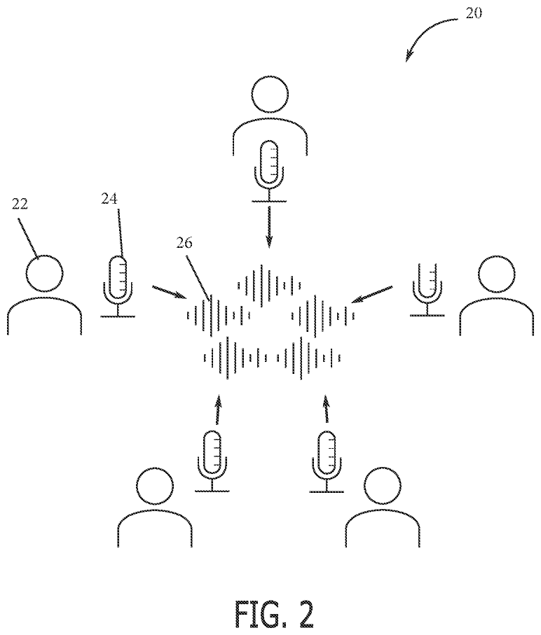

FIG. 2 shows a detailed view of the communication data being collected 20 according to an embodiment of the present invention. Audio from participants 22 is recorded with a recording device 24 and saved as recorded audio 26. The recorded audio may be stored or saved in a computer readable format.

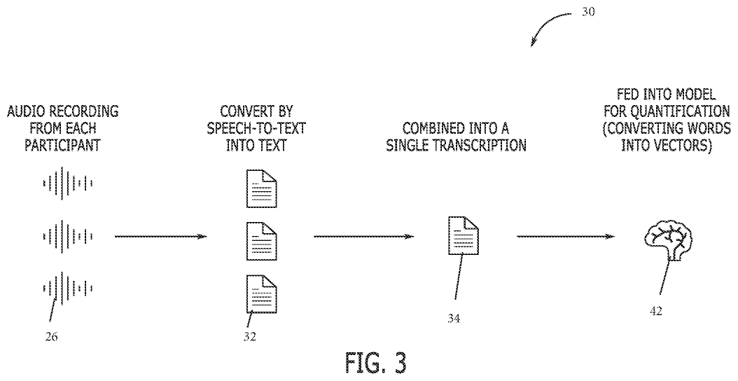

FIG. 3 depicts method steps performed by the computational infrastructure 30 according to an embodiment of the present invention. The recorded audio 26 is converted into text 32 and combined into a single transcript 34. It is then fed into a model 42 for quantification in the first embodiment of the communication representation platform 40.

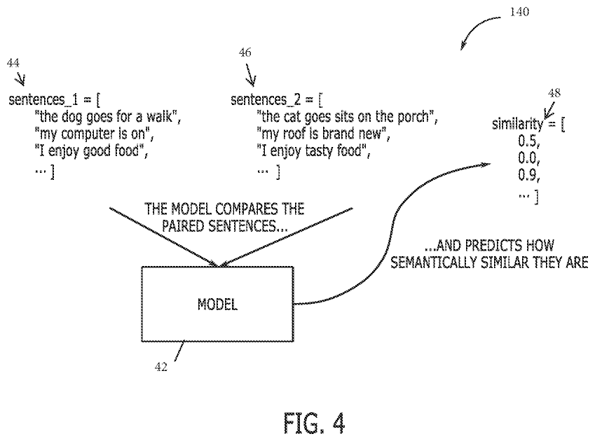

FIG. 4 depicts a combination of vector conversion of a first data set 44 and a second data set 46 and a computation of a similarity between the vectors by a model 42 within an alternate embodiment of the communication representation platform 140. The first data set 44, represented by a first sentence, and the second data set 46, represented by a second sentence, are paired and then converted into a vector or a set of vectors by the model 42 and further compared by the model 42. Multiple data sets may be compared by the model 42, sometimes simultaneously. The data sets may include excerpts of participant communication. The model 42 outputs predictions, measurements, and similarities 48 which are later converted to human-comprehensible critical factors 50 by linear algebra techniques. The predictions, measurements, and similarities 48 may be of the vector set.

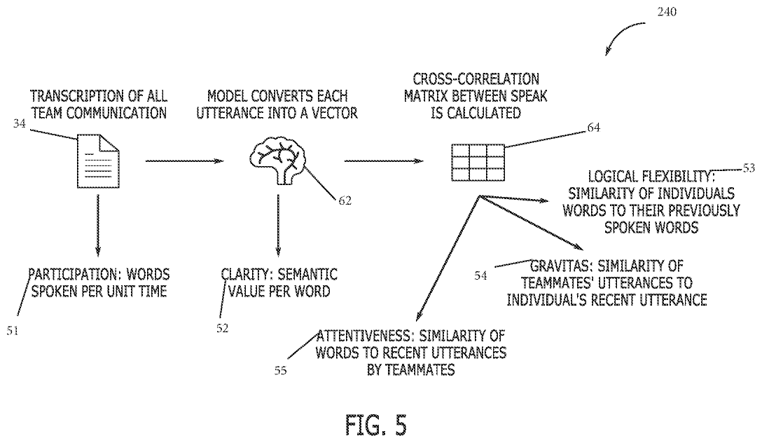

FIG. 5 details a method for generating, calculating, or determining human-comprehensible critical factors 50 within a third embodiment of the communication representation platform 240. In the embodiment, a linear algebra technique is applied to the single transcript 34 to generate a participation score 51. A, sometimes different, linear algebra technique is applied to a vector 62 generated by the model 42 to generate a clarity score 52. A matrix 64 generated by a linear algebra technique and an output of the model 42 is utilized to calculate a logical flexibility score 53, a gravitas score 54, and an attentiveness score 55. The linear algebra techniques utilized in the embodiment are not particularly limited by the present invention and a variety of linear algebra techniques may be utilized. A suitable linear algebra technique may be utilized for a predetermined category of score.

In some embodiments of the present invention, the first embodiment of the communication representation platform 40 may perform the tasks, duties, and functions depicted in FIGS. 4 and 5 by the second embodiment of the communication representation platform 140 and the third embodiment of the communication representation platform 240. Multiple embodiments were depicted for illustrative purposes and clarity.

It should be understood, of course, that the foregoing relates to exemplary embodiments of the invention and that modifications may be made without departing from the spirit and scope of the invention as set forth in the following claims.

What is claimed is:

1. A system for evaluating communication of a participant in a team setting comprising:
communication data of at least one participant;
a computational infrastructure configured to receive the communication data and transpose the communication data into a machine-readable transcription;
a communication representation platform configured to receive the machine-readable transcription wherein the communication representation platform includes a machine-readable program code for causing, when executed, the communication representation platform to perform a system method comprising the following process steps:
selecting at least one data set from the machine-readable transcription;
applying a linear algebra technique to the at least one data set; and
generating at least one score for the at least one data set; and
a human-comprehensible output wherein the human-comprehensible output comprises at the least one score generated by the communication representation platform.

2. The system of claim 1, wherein selecting at least one data set from the machine-readable transcription further comprises the following steps:
extracting a series of data from the machine-readable transcription;
inputting the series of data into a model;
converting words of the series of data into a set of vectors by the model; and
generating the at least one data set from the set of vectors.

3. The system of claim 1, wherein selecting at least one data set from the machine-readable transcription further comprises the following steps:
Extracting a series of data from the machine-readable transcription;
inputting the series of data into a model;
converting words of the series of data into a set of vectors by the model;
comparing similarities in the set of vectors by the model; and
generating the at least one data set from the set of vectors and the similarities in the set of vectors.

4. The system of claim 1, wherein the communication data is collected by an audio recording device.

5. The system of claim 1, wherein the communication data is at least one recording in an audio format.

6. The system of claim 5, further comprising a program product comprising machine-readable program code for causing, when executed, the computational infrastructure to perform a conversion method comprising the following process steps:
converting the at least one recording in an audio format to at least one text format; and
aligning the at least one text format by information in a metadata of the at least one text format.

7. The system of claim 6, wherein the conversion method further comprises combining the at least one text format into a single transcription.

8. The system of claim 1, wherein the communication data is a text format.
